(19) United States
(12) Patent Application Publication
(10) Pub. No.: US 2019/0230242 A1
(43) Pub. Date: Jul. 25, 2019

(54) IMAGE PROCESSING APPARATUS, FORMAT CONVERSION METHOD, AND COMPUTER PROGRAM

(71) Applicant: KONICA MINOLTA, INC., Tokyo (JP)

(72) Inventors: Keita Minami, Amagasaki-shi (JP); Toshinobu Yamaguchi, Osaka (JP)

(73) Assignee: KONICA MINOLTA, INC., Tokyo (JP)

(21) Appl. No.: 16/245,399

(22) Filed: Jan. 11, 2019

(30) Foreign Application Priority Data
Jan. 19, 2018 (JP) 2018-007429

(51) Int. Cl. H04N 1/04; G06F 16/11

(52) U.S. Cl. CPC H04N 1/0417; H04N 2201/0094; H04N 1/042; G06F 16/116

(57) ABSTRACT

An image processing apparatus that converts a format of image data by using any of a plurality of existing conversion programs, includes: a register that performs, by selecting at least one group including N number of conversion programs among the plurality of conversion programs such that a format after conversion by a (K−1)th conversion program coincides with a format before conversion by a Kth conversion program, registration processing of registering each of the selected at least one group as a program set; and a converter that converts, in a case where any of the at least one program set is designated, the format of the image data by sequentially using the N number of conversion programs included in the designated program set among the plurality of conversion programs, from a first conversion program of the N number of conversion programs.

The entire disclosure of Japanese patent Application No. 2018-007429, filed on Jan. 19, 2018, is incorporated herein by reference in its entirety.

### BACKGROUND

### Technological Field

The present invention relates to a technique of converting a format of image data.

### Description of the Related Art

In recent years, image forming apparatuses in which the functions of, for example, a copier, a network printer, a facsimile, a scanner, and a file server are consolidated has become widespread. Such an image forming apparatus is called “all-in-one device” or “multi function peripherals (MFP)”, or the like.

Plug-ins for various uses are available for the image forming apparatus. A plurality of plug-ins is available for, for example, input processing of image data, image conversion processing, and output processing of image data.

Techniques of actualizing a workflow with a combination of these plug-ins have been proposed. An image forming apparatus described in JP 2011-23820 A is an image forming apparatus having a function of acquiring image data and distributing the image data. The image forming apparatus includes: a storage that stores respective plug-ins for input processing, image conversion processing, and output processing for image data; a joint information acquirer that acquires joint information includes plug-in information indicating the plurality of plug-ins stored in the storage; a joiner that based on the joint information acquired by the joint information acquirer, joins at least two of the plurality of plug-ins to generate a virtual plug-in; a flow setter that sets a workflow in which the plug-ins including the virtual plug-in are optionally combined; and a workflow controller that in a case where distribution processing based on the workflow is required, performs control of processing included in the workflow.

Meanwhile, in recent years, image data in various formats have been handled in an image forming apparatus. Several plug-ins for converting a format of image data are prepared for the image forming apparatus. A user uses any of the plug-ins to convert the format of the image data according to a purpose or the like.

However, depending on a combination of the original format of the image data and a format desired by the user, the user is required for using a plurality of the plug-ins, which is inconvenient for the user.

According to the conventional technique described in JP 2011-23820 A, a workflow can be actualized with a combination of a plug-in for input processing, a plug-in for image conversion processing, and a plug-in for output processing.

However, this technique is difficult to improve convenience for the user in conversion of the format of the image data.

### SUMMARY

The present invention has been made in view of the above problem, and it is an object of the present invention to improve convenience for a user in conversion of a format of image data than ever.

To achieve the abovementioned object, according to an aspect of the present invention, there is provided an image processing apparatus that converts a format of image data by using any of a plurality of existing conversion programs, and the image processing apparatus reflecting one aspect of the present invention comprises: a register that performs, by selecting at least one group including N number of conversion programs among the plurality of conversion programs such that a format after conversion by a (K−1)th conversion program coincides with a format before conversion by a Kth conversion program, registration processing of registering each of the selected at least one group as a program set; and a converter that converts, in a case where any of the at least one program set is designated, the format of the image data by sequentially using the N number of conversion programs included in the designated program set among the plurality of conversion programs, from a first conversion program of the N number of conversion programs.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of the entire configuration of an image processing system;

FIG. 2 is a diagram illustrating an example of a hardware configuration of an image forming apparatus;

FIG. 3 is a table indicating an example of an attribute data directory and attribute data;

FIG. 4 is a diagram illustrating an example of a functional configuration of the image forming apparatus;

FIG. 5 is a flowchart illustrating an example of a flow of plug-in set definition processing;

FIG. 6 is a table indicating an example of temporary data;

FIGS. 7A and 7B are tables for explaining an example of combination selection processing;

FIG. 8 is a table indicating an example of the temporary data;

FIGS. 9A and 9B are tables for explaining an example of the combination selection processing;

FIG. 10 is a table indicating an example of the temporary data;

FIG. 11 is a table indicating an example of plug-in set data;

FIG. 12 is a view illustrating an example of a plug-in set selection screen;

FIG. 13 is a view illustrating an example of an option selection screen;

FIG. 14 is a flowchart for explaining an example of a flow of entire processing by a plug-in extension program;

FIG. 15 is a table indicating a modification of the plug-in set data; and

FIG. 16 is a view illustrating a modification of the plug-in set selection screen.

### DETAILED DESCRIPTION OF EMBODIMENTS

Hereinafter, one or more embodiments of the present invention will be described with reference to the drawings. However, the scope of the invention is not limited to the disclosed embodiments.

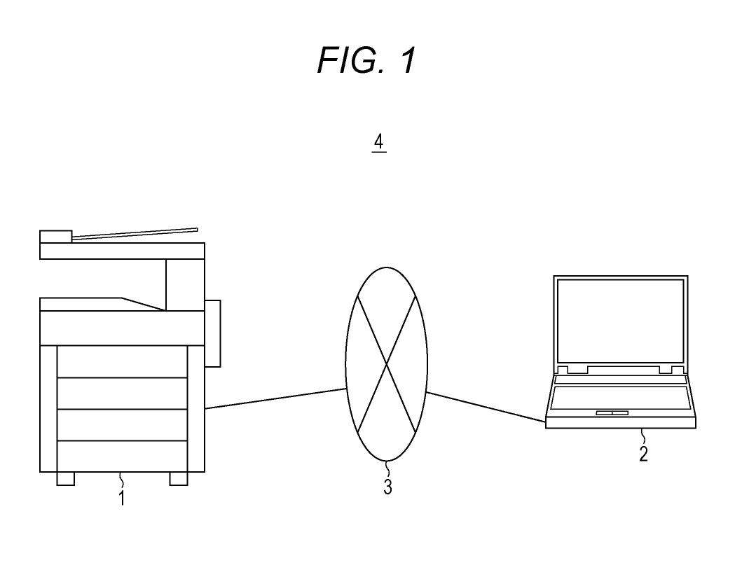

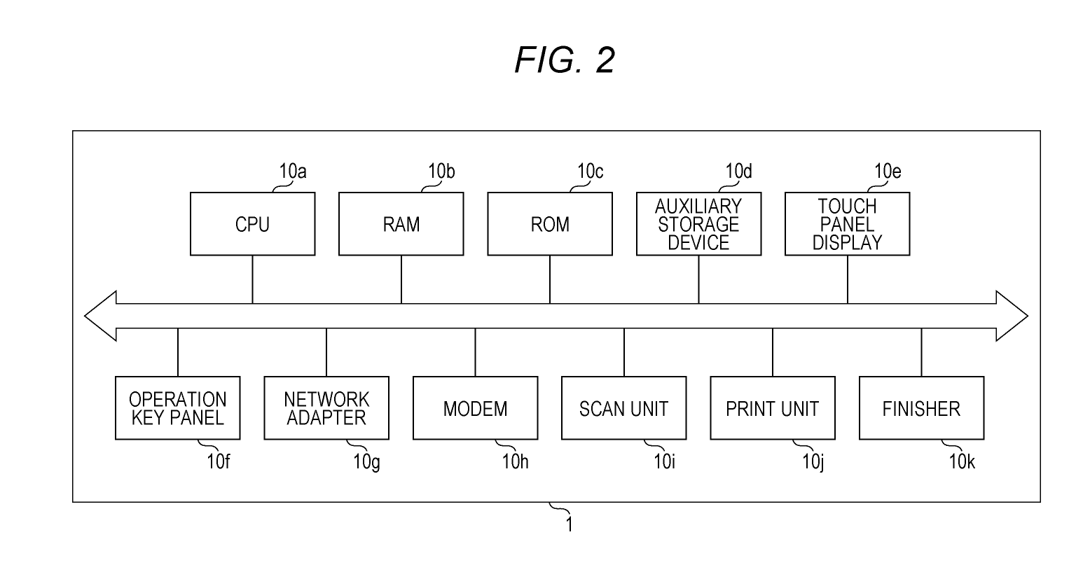

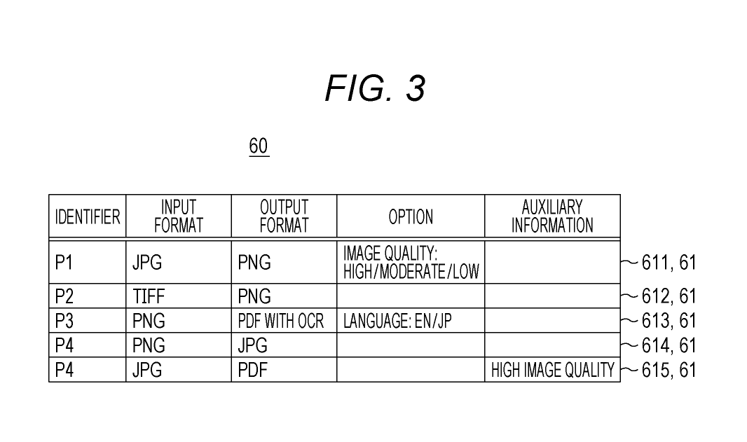

FIG. 1 is a diagram illustrating an example of the entire configuration of an image processing system 4. FIG. 2 is a diagram illustrating an example of a hardware configuration of an image forming apparatus 1. FIG. 3 is a table indicating an example of an attribute data directory 60 and attribute data 61.

The image processing system 4 illustrating in FIG. 1 is a system for printing a document on a sheet, and includes the image forming apparatus 1, a terminal device 2, a communication line 3, and the like.

The image forming apparatus 1 and the terminal device 2 can communicate with each other via the communication line 3. As the communication line 3, the Internet, an Ethernet (registered trademark) line, a wireless local area network (LAN) line, a public line, a dedicated line, or the like are used.

The image forming apparatus 1 is an apparatus that aggregates the functions of, for example, a copier, a personal computer (PC) printer, a facsimile, a scanner, and a box. In general, such an apparatus sometimes called “all-in-one device” or “multi function peripherals (MFP)”.

The PC printer function is a function of printing an image on a sheet based on image data received from the terminal device 2. This function is sometimes called “network printing” or “network print”.

The box function is a function of assigning in advance a storage region called “box” or “personal box” for each user, and storing and managing image data or the like in each user's own storage region by the user. It is also possible to provide a box with each group and share the box with members of the group. The box corresponds to “folder” or “directory” in a personal computer.

As illustrated in FIG. 2, the image forming apparatus 1 includes a central processing unit (CPU) 10a, a random access memory (RAM) 10b, a read only memory (ROM) 10c, an auxiliary storage device 10d, a touch panel display 10e, an operation key panel 10f, a network adapter 10g, a modem 10h, a scan unit 10i, a print unit 10j, a finisher 10k, and the like.

The touch panel display 10e displays a screen indicating a message to a user, a screen for the user to input a command or information, a screen indicating a result of processing executed by the CPU 10a, and the like. Furthermore, the touch panel display 10e transmits a signal indicating a touched position to the CPU 10a.

The operation key panel 10f is a so-called hardware keyboard, and includes a numeric key, a start key, a stop key, a function key, and the like.

The network adapter 10g communicates with the terminal device 2 or the like with a protocol such as transmission control protocol/internet protocol (TCP/IP). As the network adapter 10g, a network interface card (NIC) or a wireless LAN adapter or the like is used.

The modem 10h exchanges image data with a facsimile terminal with a protocol such as G3.

The scan unit 10i reads an image on a sheet set on platen glass to generate image data.

In addition to the image read by the scan unit 10i, the print unit 10j prints, onto a sheet, an image received from another device via the network adapter 10g or the modem 10h.

The finisher 10k performs post-processing on the printed sheet obtained by the print unit 10j as necessary. The post-processing includes binding processing with a staple, punch-hole opening processing, folding processing, or the like.

A plurality of programs for implementing the above-described functions such as copying is stored in the ROM 10c or the auxiliary storage device 10d. These programs include a plurality of plug-ins 5A.

The plug-in 5A is a program that converts image data from a first format into a second format. Hereinafter, the first format is described as “input format”, and the second format is described as “output format”. The combination of the input format and the output format is different for each plug-in 5A.

These plug-ins 5A are stored in a predetermined directory of the ROM 10c or the auxiliary storage device 10d. Hereinafter, the directory is described as “plug-in directory 10n”. In addition, a case where five plug-ins 5A are stored in the plug-in directory 10n will be described as an example. Each plug-in 5A is separately described as “plug-in 5A1”, “plug-in 5A2”, and “ . . . ”.

Furthermore, a plug-in extension program 5P is stored in the ROM 10c or the auxiliary storage device 10d. With the plug-in extension program 5P, the variations of format conversion can be increased without newly increasing a plug-in 5A.

These programs are loaded into the RAM 10b as necessary and executed by the CPU 10a. As the auxiliary storage device 10d, a hard disk or a solid state drive (SSD) or the like is used.

Furthermore, data indicating respective attributes of the plug-ins 5A are stored in the ROM 10c or the auxiliary storage device 10d. In the present embodiment, as indicated in FIG. 3, the attribute data directory 60 is provided in the auxiliary storage device 10d, and the attribute data 61 for each plug-in 5A is stored in the attribute data directory 60.

The following information on the plug-in 5A is indicated in the attribute data 61. An item “identifier” is a unique code for discriminating the plug-in 5A from the other plug-ins 5A. An item “input format” and an item “output format” are the input format and the output format of the plug-in 5A, respectively.

An item “option” is information on a condition under which the user can select a condition value among conditions in format conversion. Specifically, the left side of “:” (colon) is a name of the condition, and the right side is a condition value, that is, an option that the user can select.

An item “auxiliary information” is meta information on the plug-in 5A and used to notify the user of a feature of the plug-in 5A.

Hereinafter, the attribute data 61 for each of plug-ins 5A1, 5A2, and . . . is separately described as “attribute data 611”, “attribute data 612”, and “ . . . ”. Therefore, for example, the above-described each piece of information on the plug-in 5A1 is indicated in the attribute data 611.

Returning to FIG. 1, the terminal device 2 is a client of the image forming apparatus 1. The user can remotely use the functions of the image forming apparatus 1 with the terminal device 2. As the terminal device 2, a personal computer, a smartphone, a tablet computer, or the like is used.

How to increase the variations of format conversion without newly increasing a plug-in 5A will be described below.

[Definition of Plug-in Set 5B]

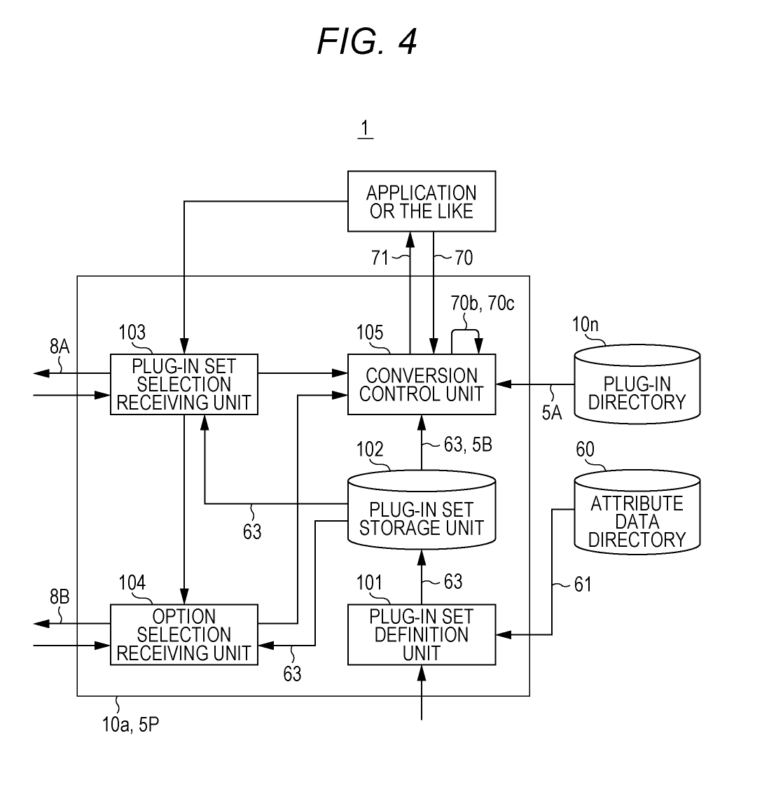

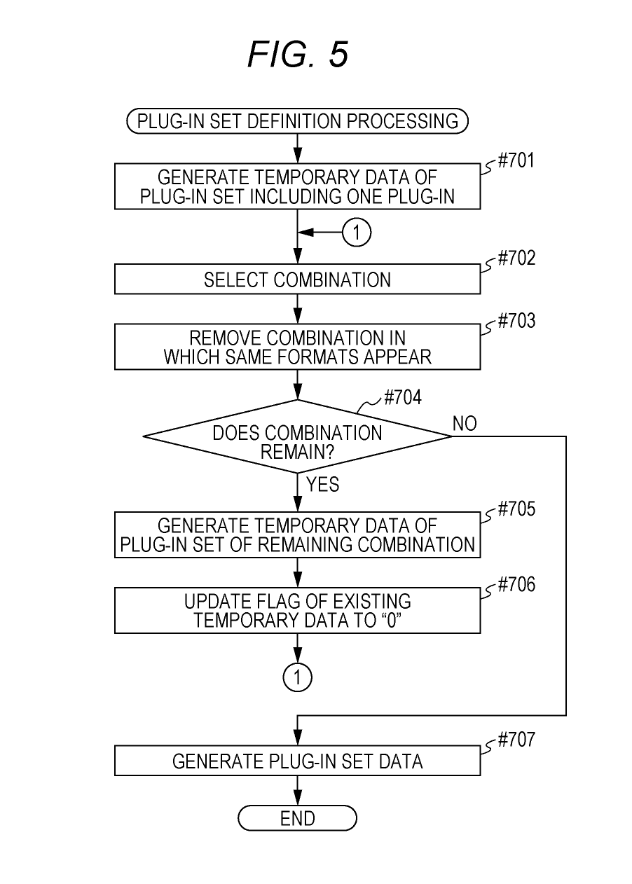

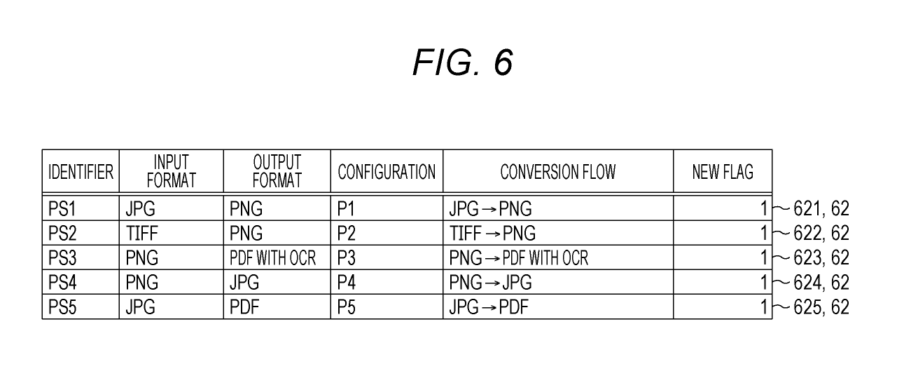

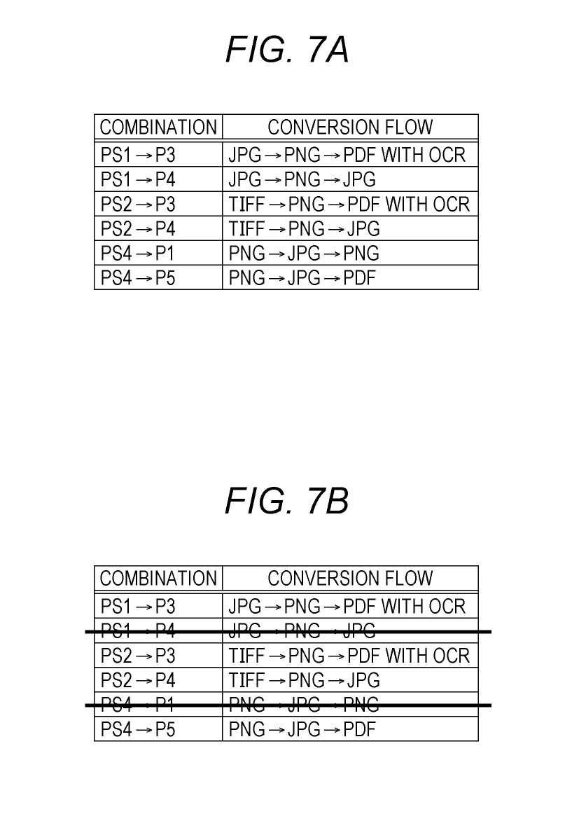

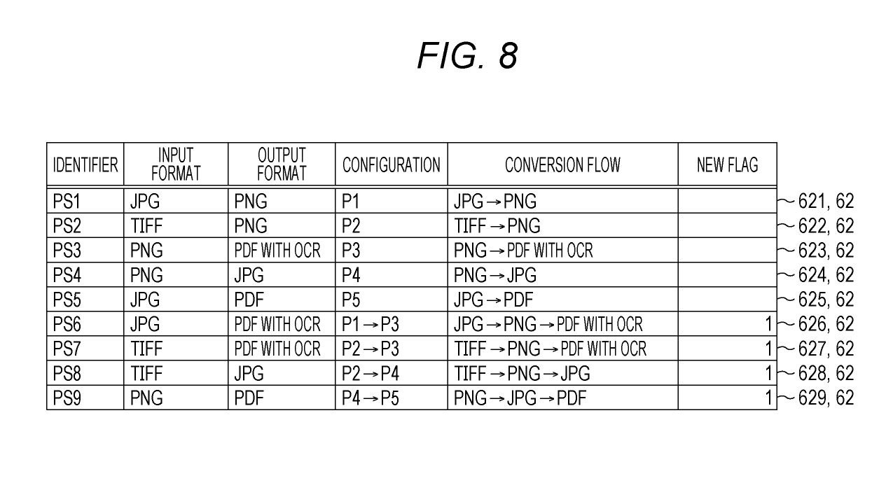

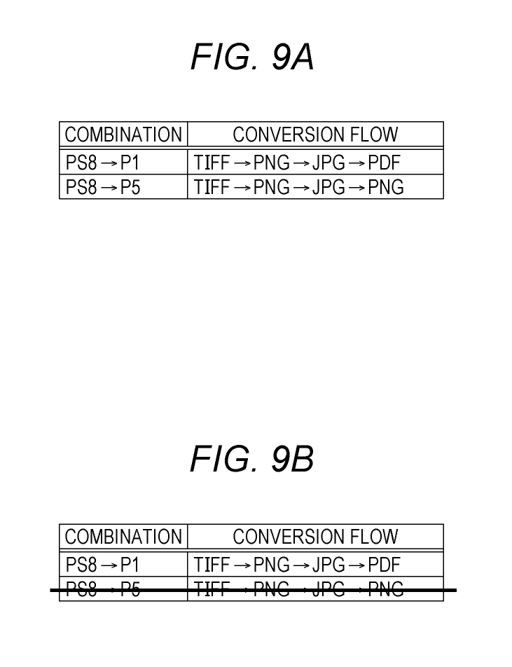

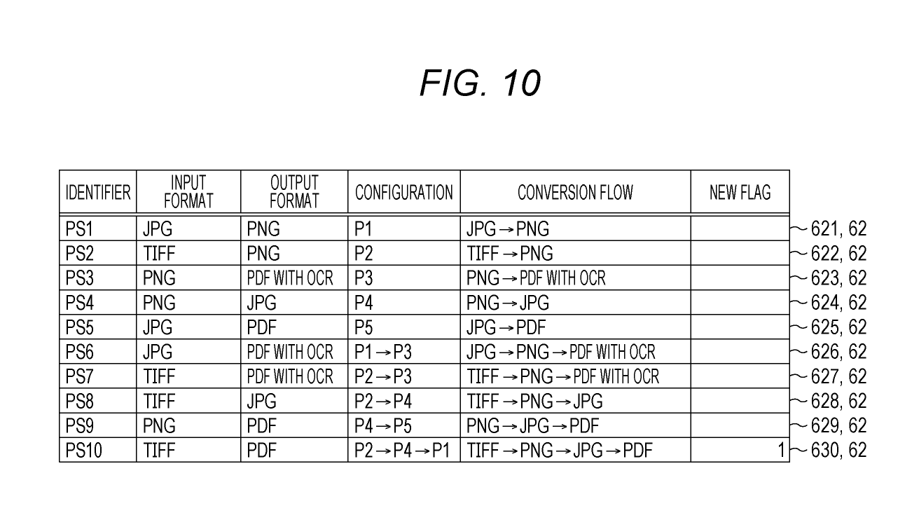

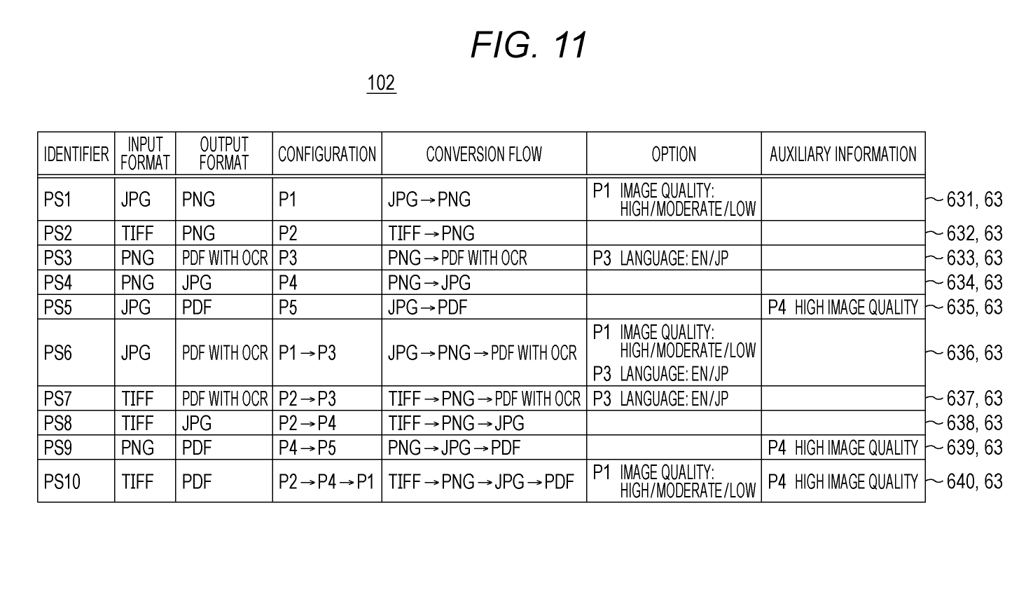

FIG. 4 is a diagram illustrating an example of a functional configuration of the image forming apparatus 1. FIG. 5 is a flowchart illustrating an example of a flow of plug-in set definition processing. FIG. 6 is a table indicating an example of temporary data 62. FIGS. 7A and 7B are tables for explaining an example of combination selection processing. FIG. 8 is a table indicating an example of the temporary data 62. FIGS. 9A and 9B are tables for explaining an example of the combination selection processing. FIG. 10 is a table indicating an example of the temporary data 62. FIG. 11 is a table indicating an example of plug-in set data 63.

With the plug-in extension program 5P, a plug-in set definition unit 101, a plug-in set storage unit 102, a plug-in set selection receiving unit 103, an option selection receiving unit 104, a conversion control unit 105, and the like illustrated in FIG. 4 are implemented by the image forming apparatus 1.

The plug-in set definition unit 101 defines a plug-in set 5B. The plug-in set 5B is a combination of one plug-in 5A or a plurality of plug-ins 5A in order of execution. Here, the procedure of processing of defining the plug-in set 5B will be described with reference to the flowchart of FIG. 5.

The plug-in set definition unit 101, for each plug-in 5A, generates the temporary data (tentative data) 62 of the plug-in set 5B including only the plug-in 5A such as indicated in FIG. 6 (#701 in FIG. 5).

Hereinafter, the temporary data 62 of each of the plug-ins 5A1, and 5A2 . . . 5A5 is separately described as “temporary data 621”, “temporary data 622”, “ . . . ”, and “temporary data 625”.

The following information on the plug-in set 5B is indicated in the temporary data 62 including the pieces of temporary data 621 to 625.

An item “identifier” is a unique code for discriminating the plug-in set 5B from the other plug-in sets 5B.

An item “input format” and an item “output format” are the input format of the first plug-in 5A included in the plug-in set 5B and the output format of the last plug-in 5A, respectively. The plug-in sets 5B1 to 5B5 each include only one plug-in 5A, so that the first plug-in 5A and the last plug-in 5A are the same. Thus, for example, the input format and the output format of the plug-in 5A1 are indicated in the temporary data 62, that is, the temporary data 621 of the plug-in set 5B1. These formats are the same as those indicated in the attribute data 61, that is, the attribute data 611 of the plug-in 5A1 (see FIG. 3).

An item “configuration” is an identifier of each plug-in 5A included in the plug-in set 5B. The plug-in sets 5B1 to 5B5 each include only one plug-in 5A, so that only one identifier is indicated as a configuration in the pieces of temporary data 621 to 625. For example, the identifier of the plug-in 5A1 is indicated as the configuration in the temporary data 621. In a case where the plurality of plug-ins 5A is included, respective identifiers of the plurality of plug-ins 5A are indicated in an order of execution.

An item “conversion flow” is a transition of the format of the image data in a case where the plug-in set 5B performs processing. The plug-in sets 5B1 to 5B5 each include only one plug-in 5A, so that the input format and the output format of the plug-in 5A each are indicated at the beginning and the end of the conversion flow, respectively. For example, as the conversion flow, the input format and the output format of the plug-in 5A1 are indicated as “JPG→PNG” in the temporary data 621.

An item “new flag” is a flag indicating whether the temporary data 62 of the plug-in set 5B is newly generated. The numeric character “1” means newly generated, and the numeric character “0” does not mean newly generated. The default is set at “1”. Therefore, “1” is indicated as a new flag at this point in each of the pieces of temporary data 621 to 625.

Next, the plug-in set definition unit 101 selects, for each of the pieces of temporary data 62 with the new flag “1”, the attribute data 61 indicating the same format as the output format indicated in the temporary data 62 as the input format, and then combines the temporary data 62 with the selected attribute data 61 (#702).

In this case, the plug-in set definition unit 101 selects, for each of the pieces of temporary data 621 to 625, the attribute data 61 indicating the same format as the output format indicated in each of the pieces of temporary data 621 to 625 as the input format. As a result, combinations (groups) such as indicated in FIG. 7A are obtained.

It can be said that each combination corresponds to a new plug-in set 5B in which an existing plug-in set 5B and an existing plug-in 5A are combined. For example, it can be said that the first combination corresponds to a new plug-in set 5B in which the plug-in set 5B1 and the plug-in 5A3 are combined.

Furthermore, the plug-in set definition unit 101 removes a combination in which the same format is indicated in the temporary data 62 and in attribute data 61 among the combinations (#703). In a case where the combination such as indicated in FIG. 7A are obtained, as indicated in FIG. 7B, the plug-in set definition unit 101 removes the combination of the temporary data 621 and the attribute data 614, and the combination of the temporary data 624 and the attribute data 611.

Then, in a case where a combination remains (Yes in #704), the plug-in set definition unit 101 generates new temporary data 62 based on the remaining combination (#705). In a case where a plurality of combinations remains, new temporary data 62 is generated based on each combination. The new temporary data 62 is that of the new plug-in set 5B.

In a case where a plurality of combinations remains as indicated in FIG. 7B, pieces of temporary data 626 to 629 as indicated in FIG. 8 are generated as the temporary data 62 of each of new plug-in sets 5B6 to 5B9 based on the respective combinations. The information indicated in each of the pieces of temporary data 62 is as described above.

Furthermore, the plug-in set definition unit 101 updates the new flag of the existing temporary data 62 to “0” (#706). In generation of the pieces of temporary data 626 to 629, the respective new flags of the pieces of temporary data 621 to 625 are updated to “0”.

The plug-in set definition unit 101 returns to step #702 and performs the above-described processing.

That is, the plug-in set definition unit 101 first selects, for each of the pieces of temporary data 62 with the new flag “1”, the attribute data 61 that satisfies the above-described conditions, and then combines the temporary data 62 with the selected attribute data 61 (#702). In this case, the plug-in set definition unit 101 selects, for each of the pieces of temporary data 626 to 629, the attribute data 61 indicating the same format as the output format indicated in each of the pieces of temporary data 626 to 629 as the input format. As a result, combinations such as indicted in FIG. 9A are obtained.

Furthermore, the plug-in set definition unit 101 removes a combination in which the same format is indicated in the temporary data 62 and the attribute data 61 among the combinations (#703). As a result, a combination such as indicated in FIG. 9B is obtained.

Then, in a case where a combination remains (Yes in #704), the plug-in set definition unit 101 generates new temporary data 62 based on the remaining combination (#705). As a result, temporary data 620 such as indicated in FIG. 10 is generated as the temporary data 62 of the new plug-in set 5B0. The new flag of the existing temporary data 62 is updated to “0” (#706). In the present example, the respective new flags of the pieces of temporary data 626 to 629 are updated to “0”.

Thereafter, similarly, the plug-in set definition unit 101 returns to step #702 and performs the processing of steps #702 to #703. In a case where a combination remains (Yes in #704), the plug-in set definition unit 101 performs the processing of steps #705 to #706. In a case where no combination remains, the processing proceeds to step #707.

Then, the plug-in set definition unit 101 generates the plug-in set data 63 such as indicated in FIG. 11 based on the temporary data 62 as follows (#707). The plug-in set definition unit 101 removes data of the new flag from the temporary data 62. Furthermore, the plug-in set definition unit 101 adds data of the option and data of the auxiliary information to the temporary data 62. Then, the option and the auxiliary information indicated in the attribute data 61 of each plug-in 5A included in the plug-in set 5B related to the temporary data 62 are indicated as the “option” and the “auxiliary information”. Note that the option and the auxiliary information each are associated in advance with the identifier of the attribute data 61 that is the origin of the option and auxiliary information.

The temporary data 62 in which the new flag is removed and the option and the auxiliary information are added in this manner is the plug-in set data 63. The plug-in set data 63 is stored in the plug-in set storage unit 102.

In a case where a plurality of pieces of temporary data 62 is provided, the plug-in set definition unit 101 generates the plug-in set data 63 based on each of the pieces of temporary data 62.

As described above, the plug-in set definition unit 101 generates the plug-in set data 63 and stores the plug-in set data 63 in the plug-in set storage unit 102, whereby the plug-in set 5B is defined.

Note that the plug-in set definition unit 101 defines the plug-in set 5B when the operating system of the image forming apparatus 1 is set up. In addition, the plug-in set definition unit 101 newly defines a plug-in set 5B when a new plug-in 5A is added to the plug-in directory 10n or when an existing plug-in 5A is removed from the plug-in directory 10n. Alternatively, the plug-in set definition unit 101 may also newly defines a plug-in set 5B even when the user inputs a predetermined command.

As a result, there is a possibility that any of the pieces of plug-in set data 63 existing at the time of the last definition is removed. Therefore, before newly defining a plug-in set 5B, the plug-in set definition unit 101 may obtain in advance the plug-in set data 63 that is to be removed and may display a message indicating that the plug-in set data 63 is to be removed. Then, when the user permits the removal, the plug-in set definition unit 101 may newly define the plug-in set 5B.

[Use of Plug-in Set 5B]

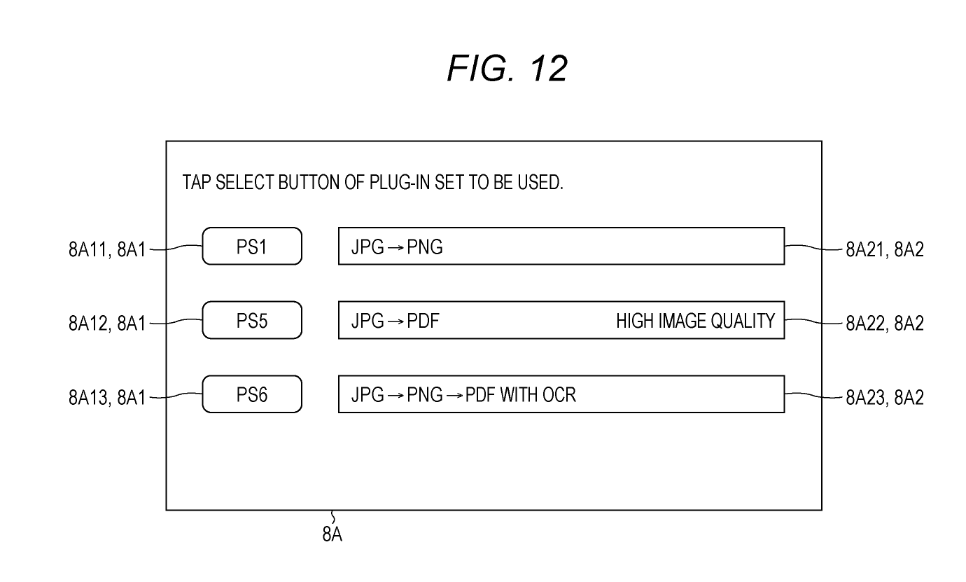

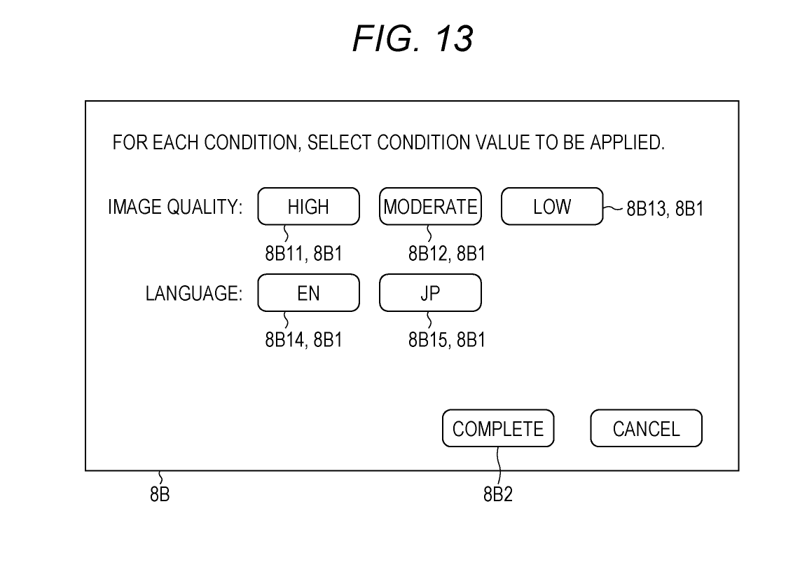

FIG. 12 is a view illustrating an example of a plug-in set selection screen 8A. FIG. 13 is a view illustration an example of an option selection screen 8B.

Next, processing with the plug-in set 5B and how to use the plug-in set 5B will be described.

With the plug-in set selection receiving unit 103 through the conversion control unit 105, a format of, for example, image data of an image read from a sheet by the scan unit 10i, image data transmitted from the terminal device 2, and image data stored in the box can be converted with the plug-in set 5B.

Processing of the plug-in set selection receiving unit 103 through the conversion control unit 105 will be described below, taking as an example of a case where the scan unit 10i converts the format of the image data of the image read from the sheet. The image data to be converted is described as “image data 70”.

When the scan unit 10i generates the image data 70, an application for scanning requests conversion of the format from the plug-in extension program 5P.

Then, the plug-in set selection receiving unit 103 performs processing of causing the user to select the plug-in set 5B as follows.

The plug-in set selection receiving unit 103 reads plug-in set data 63 indicating the format of the image data 70 as the input format among the pieces of plug-in set data 63 stored in the plug-in set storage unit 102, and displays the plug-in set selection screen 8A on the touch panel display 10e.

In a case where the format of the image data 70 is “JPG” and ten pieces of plug-in set data 63 indicated in FIG. 11 are stored in the plug-in set storage unit 102, pieces of plug-in set data 631, 635, and 636 are read and a screen such as illustrated in FIG. 12 is displayed as the plug-in set selection screen 8A.

A select button 8A1 for selecting the plug-in set 5B corresponding to each of the pieces of plug-in set data 63 that has been read and an explanatory text 8A2 indicating the conversion flow or the like are disposed on the plug-in set selection screen 8A, for each of the pieces of plug-in set data 63 that has been read. In a case where auxiliary information is indicated in the plug-in set data 63, the auxiliary information is also indicated in the explanatory text 8A2.

Here, the user taps the select button 8A1 corresponding to the plug-in set 5B that is to be applied to the image data 70. For example, in a case where the user selects the plug-in set 5B6, the user taps a select button 8A13.

When any of the select buttons 8A1 is tapped, the option selection receiving unit 104 and the conversion control unit 105 performs the following processing.

In a case where there is an option in the selected plug-in set 5B, the option selection receiving unit 104 performs processing of causing the user to select a condition value, based on the plug-in set data 63 of the plug-in set 5B as follows.

The option selection receiving unit 104 displays the option selection screen 8B on the touch panel display 10e. A select button 8B1 that can be selected by the user for the condition value in execution of the plug-in set 5B is disposed on the option selection screen 8B based on the plug-in set data 63.

For example, in a case where the selected plug-in set 5B is the plug-in set 5B6, a screen such as illustrated in FIG. 13 is displayed as the option selection screen 8B, based on the plug-in set data 636.

Here, the user selects the condition value to be applied, by tapping the corresponding select button 8B1. For example, in a case where the user selects “high image quality” and “JP” as condition values, the user taps select buttons 8B11 and 8B15. When the user competes the selection, the user taps a complete button 8B2.

Then, the conversion control unit 105 performs processing for converting the format of the image data 70 by using the selected plug-in set 5B with the selected condition value as follows.

The conversion control unit 105 reads the plug-in set data 63 of the selected plug-in set 5B from the plug-in set storage unit 102. Then, for the image data 70, each of the plug-ins 5A which identifier is indicated as the “configuration” in the plug-in set data 63 is sequentially executed from the first plug-in 5A. At this time, the selected condition value is applied.

For example, in a case where the selected plug-in set 5B is the plug-in set 5B6 and the selected condition values are the “high image quality” and the “JP”, the conversion control unit 105 applies, to the image data 70, the “high image quality” is as a condition value for image quality, and then executes the plug-in 5A1. As a result, the image data 70 is converted into image data 70b in PNG. Furthermore, the conversion control unit 105 applies, to the image data 70b, the “JP” as a condition value for language, and then executes the plug-in 5A3. As a result, the image data 70b is converted into image data 70c in PDF with OCR. The image data 70c is target image data.

In a case where there is no option in the selected plug-in set 5B, the processing performed by the option selection receiving unit 104 is omitted. Then, the conversion control unit 105 performs processing for converting the format of the image data 70 by using the plug-in set 5B, similarly to the case where there is an option, except that the selected condition value is not applied.

Hereinafter, the image data 70 converted into another format by the plug-in set 5B is described as “image data 71”. In a case where the plug-in set 5B6 is executed, the image data 70c is the image data 71. The image data 71 is passed to an application or the like of a request source of the format conversion.

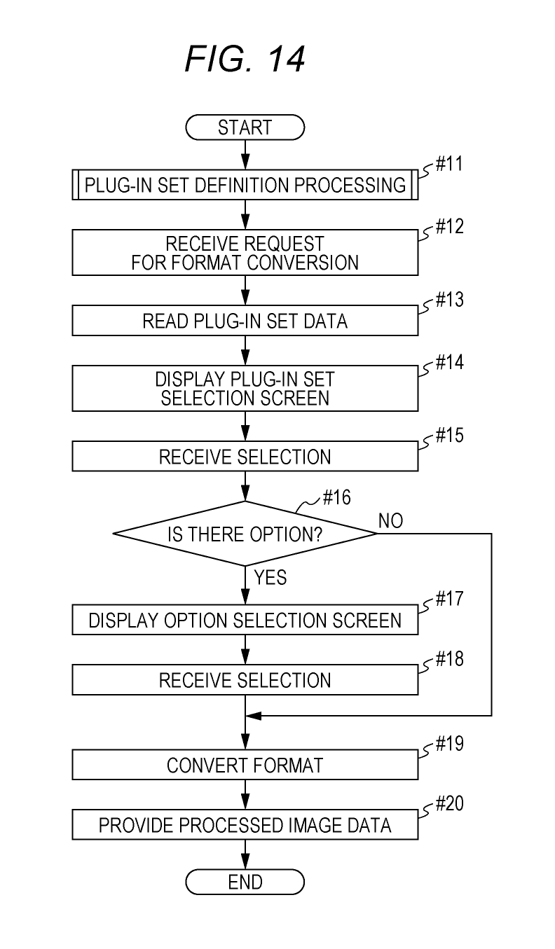

FIG. 14 is a flowchart for explaining an example of a flow of entire processing by the plug-in extension program 5P.

Next, the flow of the entire processing by the image forming apparatus 1 will be described with reference to the flowchart of FIG. 14.

Based on the plug-in extension program 5P, the image forming apparatus 1 performs processing in the procedure illustrated in FIG. 14.

The image forming apparatus 1 defines a plurality of plug-in sets 5B by using only one of the plug-ins 5A1 to 5A5, or with a combination of the plug-ins 5A1 to 5A5 (#11 in FIG. 14). Specifically, the image forming apparatus 1 generates the plug-in set data 63 of each of the plurality of plug-in sets 5B, and the plug-in set data 63 is stored in the plug-in set storage unit 102.

When receiving a request for converting the format of the image data 70, from an application or the like (#12), the image forming apparatus 1 reads, from the plug-in set definition unit 101 (#13), the plug-in set data 63 indicating the format of the image data 70 as the input format, and then displays the plug-in set selection screen 8A (see FIG. 12) based on the read plug-in set data 63 (#14).

When receiving the selection of the plug-in set 5B (#15), in a case where the selected plug-in set 5B includes a condition under which the user can select a condition value (#16), the image forming apparatus 1 displays the option selection screen 8B (#17). Then, the image forming apparatus 1 receives the selection of the condition value (#18).

Thereafter, the image forming apparatus 1 sequentially executes the plug-in 5A included in the selected plug-in set 5B, as the image data 70 to be processed, in order indicated in the “configuration” in the plug-in set data 63 of the plug-in set 5B (#19). In a case where the image forming apparatus 1 receives the selection of the condition value in step #18, the image forming apparatus 1 executes the plug-in 5A based the condition value. As a result, the image data 71 is generated. The image forming apparatus 1 passes the image data 71 to the application or the like of the request source (#20).

According to the present embodiment, the user can convert the image data 70 into a desired format without selecting and using the plurality of plug-ins 5A by the user oneself. In other words, convenience for the user in conversion of the data format of the image data 70 can be improved than ever.

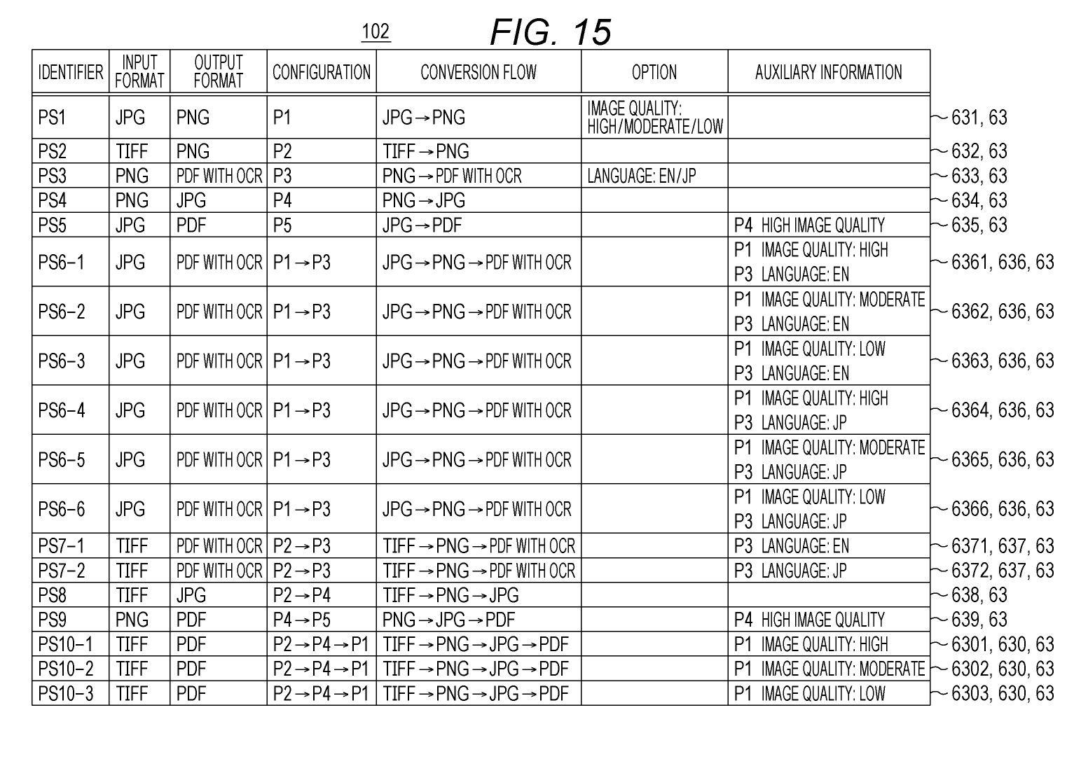

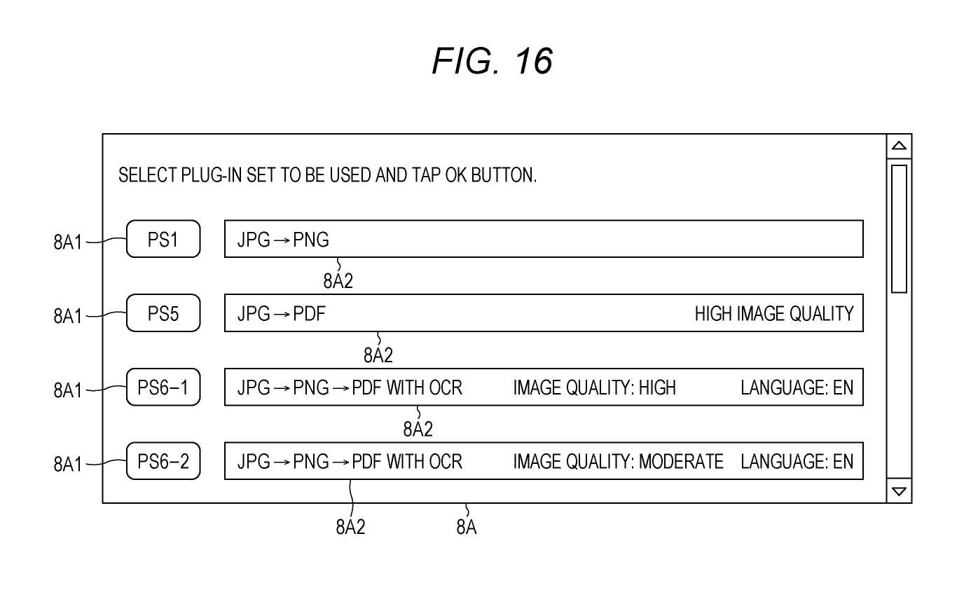

FIG. 15 is a table indicating a modification of the plug-in set data 63. FIG. 16 is a view illustrating a modification of the plug-in set selection screen 8A.

In the present embodiment, the plug-in set definition unit 101 defines the one plug-in set 5B for the one combination of the plurality of plug-ins 5A, regardless of whether any of the plug-ins 5A has a condition under which the user can select a condition value. That is, the one piece of plug-in set data 63 is generated regardless of whether the condition value can be selected.

However, in a case where any of the plug-ins 5A has such a condition, the plug-in set definition unit 101 may define a plug-in set 5B for each selectable condition value.

For example, it is assumed that the plug-in set definition unit 101 obtains ten pieces of plug-in set data 63 as indicated in FIG. 11, as a result of the processing described in FIG. 5. Among these pieces of plug-in set data 63, plug-in set data 63 in which the plurality of plug-ins 5A is included and that indicates a condition under which the user can select a condition value, as an option.

Then, three pieces of plug-in set data 63 (636, 637, and 630) are selected. The plug-in set definition unit 101 perform copying such that each of the pieces of plug-in set data 63 satisfies the number of condition values.

However, when more than one such condition is indicated, the plug-in set definition unit 101 performs copying such that each of the pieces of plug-in set data 63 satisfies the number of combinations of condition values. As a result, six (three by two) pieces of the plug-in set data 636, two pieces of the plug-in set data 637, and three pieces of the plug-in set data 630 are obtained.

The plug-in set definition unit 101 updates the two pieces of plug-in set data 637 such that the respective different condition values are indicated as the auxiliary information and the respective options are NULL. Similarly, the plug-in set definition unit 101 updates the three pieces of plug-in set data 630 such that the respective different condition values are indicated as the auxiliary information and the respective options are NULL. Furthermore, the plug-in set definition unit 101 updates the six pieces of plug-in set data 636 such that the different combinations of the respective two condition values are indicated as the auxiliary information and the respective options are NULL.

As a result, as the respective pieces of plug-in set data 636, 637, and 630, pieces of plug-in set data 6361 to 6366, 6371 and 6372, and 6301 to 6303 such as illustrated in FIG. 15 are generated.

The plug-in set selection receiving unit 103 generates a screen such as illustrated in FIG. 16 as the plug-in set selection screen 8A.

In a case where a condition value is indicated as the auxiliary information in the plug-in set data 63 of the plug-in set 5B selected by the user, the conversion control unit 105 applies the condition value to execute the plug-in set 5B.

In the present embodiment, the plug-in set definition unit 101 describes, in the plug-in set data 63, the auxiliary information (meta information) indicated in the attribute data 61 as a specification of the plug-in set 5B. However, the plug-in set definition unit 101 may describe, as the auxiliary information, a comprehensive feature obtained based on respective features of the plug-ins 5A included in the plug-in set 5B.

For example, the plug-in set definition unit 101 describes in advance, in the respective pieces of attribute data 61 of the plug-ins 5A, the execution rate (rate of converting a format of image data with a predetermined size) of each plug-in 5A as the auxiliary information. The plug-in set definition unit 101 calculates the time taken to perform processing the image data with the predetermined size by the plug-in set 5B, based on the execution rate of each plug-in 5A included in the plug-in set 5B. Then, the plug-in set definition unit 101 generates the plug-in set data 63 of the plug-in set 5B such that the calculated time is indicated as the auxiliary information.

Alternatively, the plug-in set definition unit 101 may obtain the size or the resolution of the image data 71 that is generated with the plug-in set 5B, and may generate the plug-in set data 63 such that the size or the resolution of the image data 71 is indicated as the auxiliary information. For example, in a case where the plug-in set 5B includes two plug-ins 5A and both of the two plug-ins 5A can perform format conversion while maintaining the resolution of the image data 70 at high resolution, the plug-in set definition unit 101 generates the plug-in set data 63 such that “high resolution” is indicated as the auxiliary information. However, in a case where although one plug-in 5A can perform format conversion while maintaining the resolution of the image data 70 at high resolution, the other plug-in 5A degrades the resolution, the plug-in set definition unit 101 generates the plug-in set data 63 such that information except the “high resolution”, for example, “resolution down” is indicated as the auxiliary information.

In the present embodiment, as an option for selecting the plug-in set 5B, the plug-in set selection receiving unit 103 disposes the button with the identifier of the plug-in set 5B indicated like the select button 8A1 on the plug-in set selection screen 8A (see FIG. 12). However, the plug-in set selection receiving unit 103 may dispose a button with the output format of the plug-in set 5B indicated. Alternatively, a button with the input format of the plug-in set 5B indicated may be disposed.

Alternatively, the plug-in set selection receiving unit 103 unit may select plug-in set data 63 indicating the format of the image data 70 as the input format and indicating a format designated by the user in advance as the output format, and may dispose, on the plug-in set selection screen 8A, the select button 8A1 and the explanatory text 8A2 of the plug-in set 5B of the selected plug-in set data 63.

Alternatively, instead of presenting the plug-in set 5B of the plug-in set data 63 indicating the format of the image data 70 as the input format on the plug-in set selection screen 8A, the plug-in set selection receiving unit 103 may present the plug-in set 5B of plug-in set data 63 indicating a format designated by the user as the input format. Alternatively, the plug-in set selection receiving unit 103 may present the plug-in set 5B of plug-in set data 63 indicating a format designated by the user as the output format. Alternatively, the plug-in set selection receiving unit 103 may present the plug-in set 5B of plug-in set data 63 indicating a first format designated by the user as the input format and indicating a second format designated by the user as the output format.

In the present embodiment, in a case where, in the plug-in set 5B, a plurality of conditions under which the user can select respective condition values is provided, the option selection receiving unit 104 displays a screen as the option selection screen 8B on which the condition values of these conditions can be collectively selected (see FIG. 13). However, the option selection receiving unit 104 may sequentially display a screen for each condition so as to allow the user to select the condition value. Alternatively, the option selection receiving unit 104 may sequentially display the screen for each plug-in 5A included in the plug-in set 5B so as to allow the user to select the condition value.

In the present embodiment, the option selection receiving unit 104 allows the user to designate a condition value by selecting among the options. However, the option selection receiving unit 104 allows the user to designate a condition value by inputting a numerical value or the like in a text box.

Furthermore, the entire configuration or each part configuration, the processing details, the processing order, the data configuration, the screen configuration, and the like for the image processing system 4 and the image forming apparatus 1 can be appropriately changed in accordance with the gist of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus that converts a format of image data by using any of a plurality of existing conversion programs, the image processing apparatus comprising:
a register that performs, by selecting at least one group including N number of conversion programs among the plurality of conversion programs such that a format after conversion by a (K−1)th conversion program coincides with a format before conversion by a Kth conversion program, registration processing of registering each of the selected at least one group as a program set; and
a converter that converts, in a case where any of the at least one program set is designated, the format of the image data by sequentially using the N number of conversion programs included in the designated program set among the plurality of conversion programs, from a first conversion program of the N number of conversion programs.

2. The image processing apparatus according to claim 1,
wherein the register performs, when a storage stores data indicating an identifier of a member included in the program set among the plurality of conversion programs and an order of executing the member, the registration processing on each of the at least one program set.

3. The image processing apparatus according to claim 1, further comprising
a displayer that displays, on a display, a list of at least one coincidence program set in which the format before the conversion by the first conversion program among the at least one program set coincides with the format of the image data,
wherein the converter converts the format of the image data by a coincidence program set designated among the at least one coincidence program set.

4. The image processing apparatus according to claim 3,
wherein the displayer displays, on the display, a specification of each of the at least one coincidence program set together with the list.

5. The image processing apparatus according to claim 4,
wherein the displayer displays, as the specification of each of the at least one coincidence program set, a comprehensive feature obtained based on respective features of the N number of conversion programs included in the coincidence program set.

6. The image processing apparatus according to claim 1,
wherein the converter converts the format of the image data by a program set in which the format before the conversion by the first conversion program among the at least one program set coincides with the format of the image data and a designated format coincides with the format after the conversion by an Nth conversion program.

7. The image processing apparatus according to claim 1,
wherein the converter converts the format of the image data by a program set in which the format before the conversion by the first conversion program among the at least one program set coincides with a first format that is designated and the format after the conversion by an Nth conversion program coincides with a second format that is designated.

8. The image processing apparatus according to claim 1, further comprising
a second displayer that displays, in a case where any of the N number of conversion programs included in the designated program set has a condition under which a user is able to designate a value, a designation screen for designating the value on a display,
wherein the converter converts the format of the image data based on the designated value on the designation screen.

9. The image processing apparatus according to claim 8,
wherein, in a case where a plurality of the conditions is provided, the second displayer displays a screen for designating the respective values of the plurality of the conditions as the designation screen.

10. The image processing apparatus according to claim 8,
wherein, in a case where a plurality of the conditions is provided, the second displayer sequentially displays a screen for each of the plurality of the conditions as the designation screen.

11. The image processing apparatus according to claim 1,
wherein the register performs again the registration processing, when a new conversion program is added as one of the plurality of conversion programs or any of the plurality of conversion programs is removed.

12. The image processing apparatus according to claim 11, further comprising
a message displayer that displays a message in order to issue a notification for a program set to be removed by performing again the registration processing by the register, among the at least one program set,
wherein, in a case where a user permits the removal, the register performs again the registration processing.

13. The image processing apparatus according to claim 1,
wherein the register performs the registration processing when the image data is input.

14. The image processing apparatus according to claim 1,
wherein the register registers a group including only one of the plurality of conversion programs as the program set.

15. A format conversion method of converting a format of image data by using any of a plurality of existing conversion programs, the format conversion method comprising:
by selecting at least one group including N number of conversion programs among the plurality of conversion programs such that a format after conversion by a (K−1)th conversion program coincides with a format before conversion by a Kth conversion program, registering each of the selected at least one group as a program set; and
converting, in a case where any of the at least one program set is designated, the format of the image data by sequentially using the N number of conversion programs included in the designated program set among the plurality of conversion programs, from a first conversion program of the N number of conversion programs.

16. A non-transitory recording medium storing a computer readable computer program to be used for a computer that converts a format of image data by using any of a plurality of existing conversion programs, the computer readable computer program causing the computer to perform:
by selecting at least one group including N number of conversion programs among the plurality of conversion programs such that a format after conversion by a (K−1)th conversion program coincides with a format before conversion by a Kth conversion program, registering each of the selected at least one group as a program set; and
converting, in a case where any of the at least one program set is designated, the format of the image data by sequentially using the N number of conversion programs included in the designated program set among the plurality of conversion programs, from a first conversion program of the N number of conversion programs.
